(19) United States
(12) Patent Application Publication
(10) Pub. No.: US 2024/0109413 A1
(43) Pub. Date: Apr. 4, 2024

(54) REAL-TIME AUTONOMOUS SEAT ADAPTATION AND IMMERSIVE CONTENT DELIVERY FOR VEHICLES

(71) Applicant: Intel Corporation, Santa Clara, CA (US)

(72) Inventors: Rajesh Poornachandran, Portland, OR (US); Ned M. Smith, Beaverton, OR (US); Kathiravetpillai Sivanesan, Portland, OR (US); Satish Chandra Jha, Portland, OR (US); Vesh Raj Sharma Banjade, Portland, OR (US); Arvind Merwaday, Beaverton, OR (US); S M Iftekharul Alam, Hillsboro, OR (US); Andradige Silva, Portland, OR (US); Selvakumar Panneer, Portland, OR (US)

(21) Appl. No.: 17/956,485

(22) Filed: Sep. 29, 2022

(51) Int. Cl. B60K 35/00; G06N 20/00

(52) U.S. Cl. CPC B60K 35/00; G06N 20/00; B60K 2370/161; B60K 2370/177; B60K 2370/731; B60K 2370/741

(57) ABSTRACT

Various systems and methods for content adaptation based on seat position or occupant position in a vehicle are described herein. An example implementation for content adaptation based on seat position in a vehicle includes: obtaining sensor data, the sensor data including a seat position of a seat in the vehicle; identifying audiovisual content for output to a human occupant in the vehicle; identifying an occupant position of the human occupant, based on the seat position, for a user experience of the output of the audiovisual content; and cause one or more adjustments to the output of the audiovisual content in the vehicle, via an output device, based on the identified position of the human occupant.

### TECHNICAL FIELD

Embodiments described herein generally relate to vehicle equipment and control systems, and in particular, to features of a vehicle for adapting seat position and controlling presentation of multimedia experiences in a vehicle.

### BACKGROUND

A variety of vehicle types are used to transport human occupants, while also offering occupants different forms of information and entertainment (often referred to as “infotainment”). In the automotive context, a variety of controls have been developed and deployed to automate, adapt, and enhance occupant comfort and provide improved experiences for infotainment during vehicle operation (and, during other uses of the vehicles, such as before and after trips).

Personal automotive transportation vehicles, such as cars and trucks, often have fixed seats and an audio (or, audio/video) experience that is calibrated to the fixed positions of the seats. Examples include speakers being aimed to a particular seat location, or a screen that is optimized to a viewing angle of an occupant who is seated in a particular seat location and position.

With a growing share of autonomous vehicles combined with 5G/6G edge networking disruption, it is expected that a variety of high fidelity/quality immersive experience and content (e.g., 4K or 8K high resolution video, or 360 degree immersive presentations) may be streamed to autonomous vehicles. This may include audiovisual content to be presented for an entire vehicle cabin, as well as single-viewer or collaborative user experiences that may be partially or fully immersive. One such example of an immersive experience is a 3-D movie presented from (e.g., visualized on) a ceiling of a vehicle, accompanied by directional sound effects.

As vehicle automation increases, it is expected that new driving and passenger arrangements will be adopted, including seats which can be positioned at different angles, orientations, or locations within a vehicle. Accordingly, many technical challenges are presented by the deployment of immersive or interactive content within a vehicle having re-positionable seats.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing of a vehicle system adapted to provide immersive content and multimedia user experiences using adaptive seating, according to an example;

FIG. 2 is a block diagram of processing engines operable with a vehicle system, according to an example;

FIG. 3 is a block diagram of a system architecture for controlling and offering immersive content in a vehicle system, according to an example;

FIG. 4 is a flow diagram illustrating operational flow for real-time autonomous seat adaptation, according to an example;

FIG. 5 is a flow chart illustrating configuration and operation of real-time autonomous seat adaptation, according to an example;

FIG. 6 is a flow chart of a method for implementing real time autonomous seat adaptation (RTASA), according to an example;

FIG. 7 illustrates a vehicle compute and communication use case involving mobile access to applications in an edge computing system, according to an example;

FIG. 8 is a block diagram illustrating an example machine upon which any one or more of the techniques (e.g., methodologies) discussed herein may perform, according to an example.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

New forms of autonomous (and semi-autonomous) vehicles are expected to provide seats that can swirl, move, rotate, change angle, etc. for improved user experience before, during, and after vehicle movement. For instance, it is expected that such vehicles will allow seats to be repositioned to better enable occupants to get into the vehicle, get out of the vehicle, interact with peer passengers (e.g., as people would naturally do in a living room or conference room), or even to use metaverse and virtual reality sessions during transit. Existing infotainment and immersive systems that are targeted to a fixed seat location may not be compelling or effective due to dynamic positioning of occupants in a vehicle.

Existing approaches for infotainment delivery often output content based on the assumption that an occupant's position within the vehicle is fixed to a single seat location. Accordingly, many systems for multimedia and immersive content playback lack the capability to track or adapt to the repositioning of an occupant or the repositioning of a seat for an occupant. Further, many systems lack the ability to adapt content delivery based on policy-configurable selections and preferences by vehicle users (occupants, i.e., passengers and drivers).

The following provides various implementations of Real-time Autonomous Seat Adaptation (RTASA), including for use cases involving user-centric content delivery of immersive experiences and multimedia playback. The benefits of such adaptation and content delivery customization includes the following. First, the following implementations of RTASA introduce a capability for the vehicle systems to discover dynamic user positioning from the vehicle on-board telemetry, gaze tracking, user demography, ambient sensing, etc., to the determine and control active acoustics and screen delivery experiences for vehicle users. Second, the following implementations of RTASA introduce the capability to perform dynamic recalibration of infotainment features, including but not limited to screen angle, positioning, audio rerouting, mic placement, etc. Such recalibration enables a consistent, hassle-free immersive experience, without the need for vehicle users to adapt to devices or fixtures at fixed positions. Third, the following implementations of RTASA introduce personalization for individual occupants (or, a group of occupants), based on the content being enjoyed. This also provides the capability to perform split screen rendering, or preventing the output of inappropriate content from audio or video—even if occupants change seats or seat positions. These and other improvements will be apparent from the following discussion.

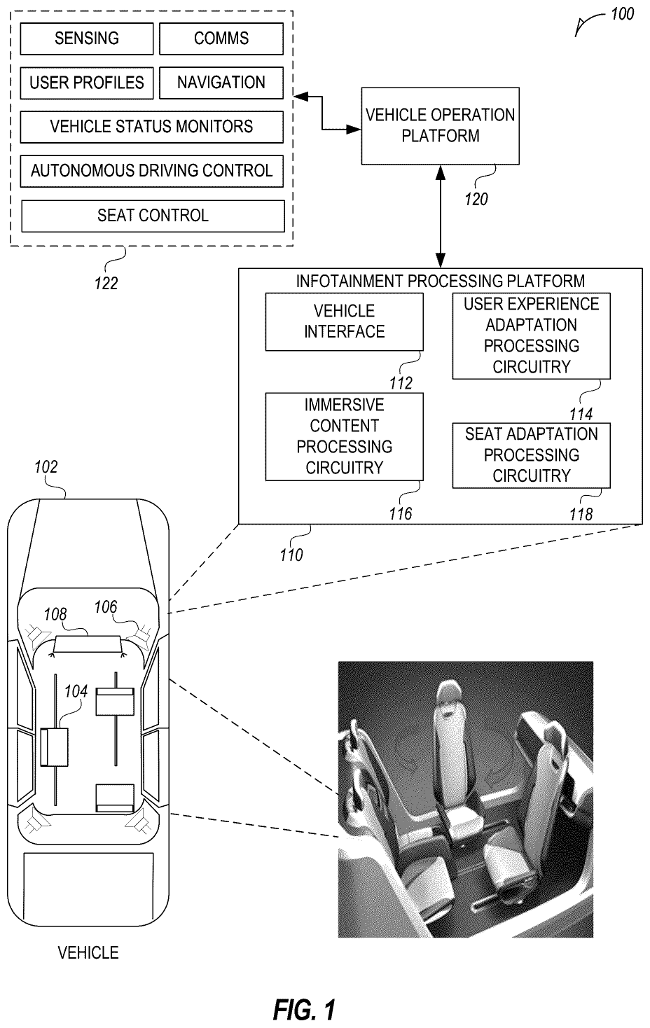

FIG. 1 is a schematic drawing illustrating a vehicular system 100 adapted to provide immersive content and multimedia user experiences using adaptive seating, according to an example. FIG. 1 specifically includes an infotainment processing platform 110 incorporated into the vehicle 102. The infotainment processing platform 110 includes a user experience adaptation processing circuitry 114 (e.g., a processor or SoC), an immersive content processing circuitry 116 (e.g., the same or a different processor or SoC), seat adaptation processing circuitry 118 (the same or a different processor or SoC) and a vehicle interface 112 (e.g., a communication bus to communicatively couple the processing platform 110 with a vehicle operation platform).

The vehicle 102, which may also be referred to as an “ego vehicle” or “host vehicle”, may be any type of vehicle, such as a commercial vehicle, a consumer vehicle, a recreation vehicle, a car, a truck, a bus, a motorcycle, a boat, a drone, a robot, an airplane, a hovercraft, or any mobile craft able to operate at least partially in an autonomous mode. The vehicle 102 may operate at some times in a manual mode where the driver operates the vehicle 102 conventionally using pedals, a steering wheel, or other controls. At other times, the vehicle 102 may operate in a fully autonomous mode, where the vehicle 102 operates without user intervention. In addition, the vehicle 102 may operate in a semi-autonomous mode, where the vehicle 102 controls many of the aspects of driving, but the driver may intervene or influence the operation using conventional (e.g., steering wheel) and non-conventional inputs (e.g., voice control). Although the vehicle 102 is depicted as a consumer multi-passenger automobile with multiple seats 104, it will be understood that the following infotainment environments and processing functions may be applicable to widely differing vehicle types and form factors (such as bus, train, or airplane cabins).

The vehicle 102 may include one or more speakers 106 that are capable of projecting sound within the vehicle 102, and one or more displays 108 that are capable of outputting video or graphical content within the vehicle. The speakers 106 or the displays 108 may be integrated among the vehicle cabin, such as in cavities, dashes, or seats within the cabin of the vehicle 102. The displays 108 may include one or more screens, projectors, or accessory (e.g., wearable) devices to provide the video or graphical content outputs to occupants (also referred to herein as “users”) in the one or more seats 104. The speakers 106 and displays 108 may be provided signals through the vehicle interface 112 from the immersive content processing circuitry 116. The immersive content processing circuitry 116 or user experience adaptation processing circuitry 114 may drive the speakers 106 and the displays 108 in a coordinated manner, such as directional audio output and video output, based on the particular position of the one or more seats 104, as discussed below.

The vehicle interface 112 uses input or output signaling between the infotainment processing platform 110 and one or more sensors of a sensor array or sensing system installed on the vehicle 102 (e.g., provided by vehicle components 122 accessible via the vehicle operation platform 120). Examples of sensors include, but are not limited to microphones; cabin, forward, side, or rearward facing cameras; radar; LiDAR; ultrasonic distance measurement sensors; or other sensors. Forward-facing or front-facing is used in this document to refer to the primary direction of travel, e.g., the direction the seats are arranged to face by default, the direction of travel when the transmission is set to drive, or the like. Conventionally then, rear-facing or rearward-facing is used to describe sensors that are directed in a roughly opposite direction than those that are forward or front-facing.

The vehicle 102 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like. Sensor data can used to determine the vehicle's operating context, environmental information, road conditions, travel conditions, or the like. For example, in some of the use cases discussed below, the vehicle interface 112 may communicate with another interface or subsystem of the vehicle components 122, to obtain information or control some feature based on seat or occupant positioning.

Components of the infotainment processing platform 110 may communicate with components internal to the infotainment processing platform 110 or components that are external to the processing platform 110 using a network, which may include local-area networks (LAN), wide-area networks (WAN), wireless networks (e.g., 802.11 or cellular network), ad hoc networks, personal area networks (e.g., Bluetooth), vehicle-based networks (e.g., Controller Area Network (CAN) BUS), or other combinations or permutations of network protocols and network types. The network may include a single local area network (LAN) or wide-area network (WAN), or combinations of LANs or WANs, such as the Internet. The various devices coupled to the network may be coupled to the network via one or more wired or wireless connections.

As an example, the infotainment processing platform 110 may communicate with the vehicle operation platform 120. The vehicle operation platform 120 may be a component of a larger architecture that controls or monitors various aspects of the vehicle's operation (depicted as the vehicle components 122). The vehicle operation platform 120 therefore may provide interfaces to autonomous driving control systems (e.g., steering, braking, acceleration, etc.), comfort systems (e.g., heat, air conditioning, seat positioning, etc.), navigation interfaces (e.g., maps and routing systems, positioning systems, etc.), collision avoidance systems, communication systems, security systems, vehicle status monitors (e.g., tire pressure monitor, battery level sensor, speedometer, etc.), and the like. Using the coupled infotainment processing platform 110, the vehicle operation platform 120 may observe or control one or more subsystems, including the positioning of seats or user seating components.

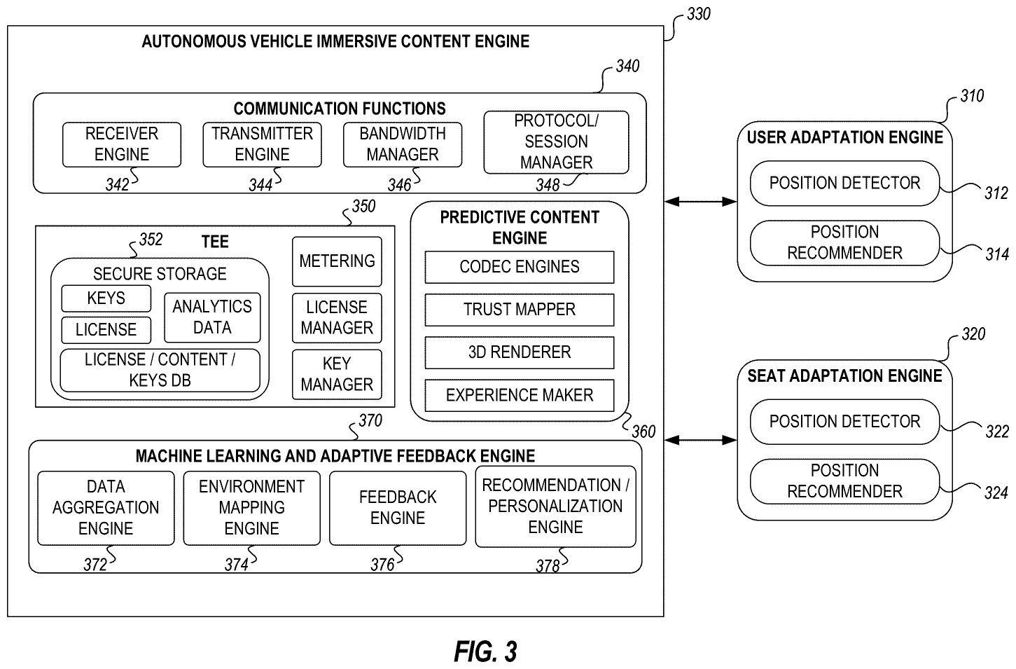

The user experience adaptation processing circuitry 114 may implement instructions (e.g., software or logic) which detects vehicle occupant positions, recommends vehicle occupant positions, and controls the output of immersive or multimedia content based on such occupant positions, as discussed with reference to FIG. 3 below. The seat adaptation processing circuitry 118 may implement instructions (e.g., software or logic) which detects seat positions (e.g., of seats 104), recommends seat positions, and controls seat positions, as discussed with reference to FIG. 3 below. The immersive content processing circuitry 116 may implement instructions (e.g., software or logic) which monitors, controls, or recommends aspects of data aggregation, environment mapping, feedback, content recommendation or personalization, or predictive content, as discussed with reference to FIG. 3 below.

Based on the RTASA capabilities and use cases discussed herein, the infotainment processing platform 110 may initiate one or more responsive activities to control the presentation or use of infotainment. The infotainment processing platform 110 may also control or monitor the vehicle 102 via the vehicle operation platform 120 or other connected systems. Accordingly, infotainment, multimedia content, or autonomous vehicle actions may be initiated depending on the type, severity, location, or other aspects of an event or condition related to the use of the seats 104.

Among other features, the infotainment processing platform 110 may control and perform dynamic recalibration of multiple types of infotainment features involved with the seats 104, the speakers 106, and the displays 108, such as control or calibration of screen angle, screen positioning, audio positioning and rerouting, microphone placement, or the like, for consistent hassle-free immersive experiences. Such control and calibration provides a significant benefit relative to fixed seats or output devices (e.g., at fixed locations in the vehicle 102).

Further, the infotainment processing platform 110 may provide features for personalization of infotainment settings, controls, or positioning. Such personalization may be provided for individual passengers or occupants, or for group of passengers or occupants, based on user profiles or based on the content (or type of content) being provided. Customization can support further capabilities to perform split screen rendering for output to multiple occupants, or to preventing the output of inappropriate or unwanted content (e.g., to prevent the unintended output of audio, video, even if an occupant rotates their seat).

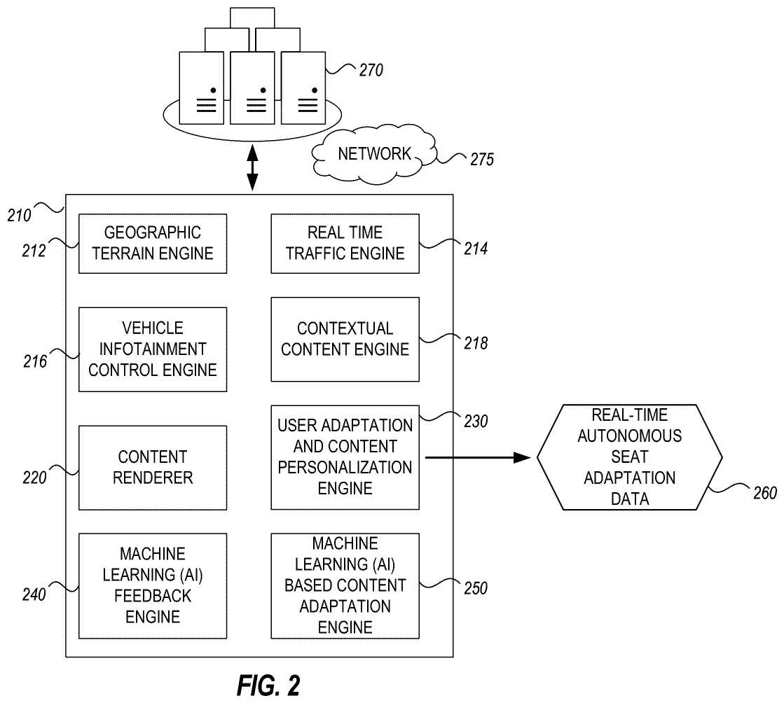

FIG. 2 is a block diagram of processing engines 210 operable with a vehicle system, such as processing engines deployable among the vehicle operation platform 120 and infotainment processing platform 110 discussed above. In particular, this diagram illustrates high level components for implementation and control of an immersive multimedia experience which coordinate with seat adaptation for repositionable vehicle seats.

Here, the processing engines 210 operable by the vehicle include: geographic terrain engine 212 (e.g., to adapt vehicle, seat, or infotainment operations based on the geographic terrain being traveled); a real time traffic engine 214 (e.g., to adapt vehicle, seat, or infotainment operations based on the traffic encountered by the vehicle); vehicle infotainment control engine 216 (e.g., an in-vehicle infotainment “IVI” system controller); a contextual content engine 218 (e.g., to select, change, or monitor the content provided by the vehicle infotainment system); and a content render 220 (e.g., to generate or adapt representations of the content provided by the vehicle infotainment system).

The processing engines 210 further include a user adaptation and content personalization engine 230 (e.g., to adapt vehicle, seat, or infotainment operations based on the occupant seated in the vehicle). Among other outputs, the engine 230 produces real-time autonomous seat adaptation data 260. Such data 260 may be used to control content, content presentation, or seat positioning within a vehicle. As one example, as seat movement or repositioning occurs in the vehicle—such as a new seat orientation or position that an occupant moves their seat into—the system detects the seat position, and can offer real time adaptation commands in data 260, to specify how content (e.g., immersive content) can be most effectively delivered to the occupant at the new seat position.

The processing engines 210 may coordinate to provide other features and functions discussed herein. For instance, a machine learning (artificial intelligence) feedback engine 240 and machine learning (artificial intelligence) adaptation engine 250 may operate algorithms or models for predicting and tracking user mobility according to one or more user profiles. Such user profiles may correspond to a particular vehicle occupant or a group of occupants (e.g., at a particular seat location), or to a specific human person or group of persons. Such user profiles can be coordinated with seamless content delivery, content pre-fetching, orchestration, and migration across variety of vehicles and autonomous systems. As an example, consider a scenario where a particular person can obtain a content stream that they were experiencing in a first vehicle (e.g., provided by a ride-share service), and then continue the content experience at a second vehicle or at another a destination (e.g., inside an airport lounge, airplane or other ride-share service at the destination), all while considering the seat positioning or perspective of the person within the vehicle. Other aspects of content personalization may be supported or controlled by tracking and personalization, including, consent-based personalization and appropriate privacy controls for such tracking and personalization.

The processing engines may further coordinate with a remote server system 270 (e.g., an edge computing or cloud computing system) accessible via a network 275. Other features of the processing engines 210 may involve use of geographic-based (geofenced) or time-based (e.g., time-fenced) fenced data or rules, such as to implement isolation zones that enable ad-hoc real time/near-real time collaboration opportunities based on location or rules.

FIG. 3 is a block diagram of a system architecture for controlling and offering immersive content in a vehicle. Here, this block diagram specifically shows additional engines and functions within an autonomous vehicle to support an immersive experience for the customizable output of multimedia content, based on occupant or seat positions. In such an example, the immersive experience may be provided with some combination of audiovisual (speaker, screen display), augmented reality (AR), virtual reality (VR), immersive reality (IR), or multimedia output, including as assisted by user devices (e.g., goggles, headsets, earphones, etc.). As can be understood, any of these AR/VR/IR approaches may be used to output auditory and visual features of an artificial environment in the vehicle (e.g., to replace a user's real-world surroundings with the auditory and visual features while seated as an occupant in the vehicle).

An immersive content engine 330 is operated to coordinate the receipt of sensory input and adapting content for specific devices/occupants, including on request, dynamically, or in real time. The immersive content engine 330 may include a feedback channel with a variety of engines and other systems (not depicted) to collect data which then can optimize machine learning and data processing convergence. The immersive content engine 330 specifically coordinates with a user adaptation engine 310 and a seat adaptation engine 320 to identify and respond to occupant and seat positioning within a vehicle. A number of sub-systems are illustrated within the immersive content engine 330 to assist such operations, including: communication functions 340, a trusted execution environment (TEE) 350, a predictive content engine (PCE) 360, and a machine learning and adaptive feedback engine 370.

The communication functions 340 may include a receiver engine 342, transmitter engine 344, bandwidth manager 346, and protocol/session manager 348. These components can be used to transmit/receive communications, perform protocol operations and session management with participating entities, and to retrieve/save user-profile and calibration information from or to another networked system (e.g., cloud system).

The TEE 350 may be provided as a tamper-resistant isolated execution environment with dedicated storage. The TEE 350 may process high value content, user privacy/sensitive information, keys, license and associated metering analytics, associated with immersive content.

The predictive content engine 360 provides appropriate predictive content recommendation and machine learning engine operations for the immersive content. This sub-system determines the dynamic latency incurred due to network, client rendering capabilities, etc., and performs appropriate content generation/scene updates to a particular person, occupant, or client on an on-demand basis.

The machine learning and adaptive feedback engine 370 generates or identifies adaptive feedback for the immersive content experience. This may be produced in the form of real time aggregation and processing of feedback data obtained from immersive experience clients and devices (e.g., seat position sensors, user configuration, tuning inputs, seat position sensors, audio feedback/noise cancellation sensors, etc.).

A first engine included in the machine learning and adaptive feedback engine 370 is a data aggregation engine 372. The data aggregation engine 372 aggregates data from a variety of input sources. A non-limiting list of input sources may include sensing devices such as inertial, imaging, radar sensing, LIDAR, etc. and in-vehicle infotainment system interfaces. This engine may be communicatively coupled with the variety of input sources directly or via an IP network to aggregate and pre-process data. Data aggregation policies can be configurable (e.g., sampling interval).

A second engine included in the machine learning and adaptive feedback engine 370 is an environment mapping engine 374. This engine takes input from the processed data from the data aggregation engine 372, such as to internally map and update the geo-terrain information. This process assists in identifying the key characteristics to the terrain to personalize content. This process also can receive real-time feedback of the user experience by using audio and imaging sensors, so that the environment mapping engine 374 can adapt content based on real-time feedback from the vehicle occupants. For example, audio feedback could be orthogonal to video/image feedback. Further, the environment mapping engine 374 can be bootstrapped/initialized using crowd-sourcing terrain contents or from previously cached experiences. In case of conflicts, the engine may revert to previous experiences.

A third engine included in the machine learning and adaptive feedback engine 370 is a feedback engine 376. Based on the adaptive feedback received from the variety of input sources, the immersive content engine 330 adapts its machine learning framework, inference, and recommendation systems. Individual users may opt-in to provide their preferences via phone apps/cloud dashboard for appropriate content calibration adaption across one or more devices.

A fourth engine included in the machine learning and adaptive feedback engine 370 is a personalization engine 378. This engine 378 provides appropriate recommendations based on learned user patterns and personalized predictive content to be delivered. The personalization engine 378 may contain a user interview interface that obtains ground truth user input from a particular person via user interviews. User interviews provide appropriate calibration for machine learning/AI-derived recommendations. For example, a machine learning model might predict a user preferred noise cancellation level that is higher or lower than is captured by user interviews. User interviews provide a baseline starting point from which machine learning models determine is an optimal starting point, user noise cancelation adjustments are learned and automatically applied based on context variables (e.g., speed of vehicle, mix of other passengers, weather, type of display or audio content, speaker position relative to seat position, etc.).

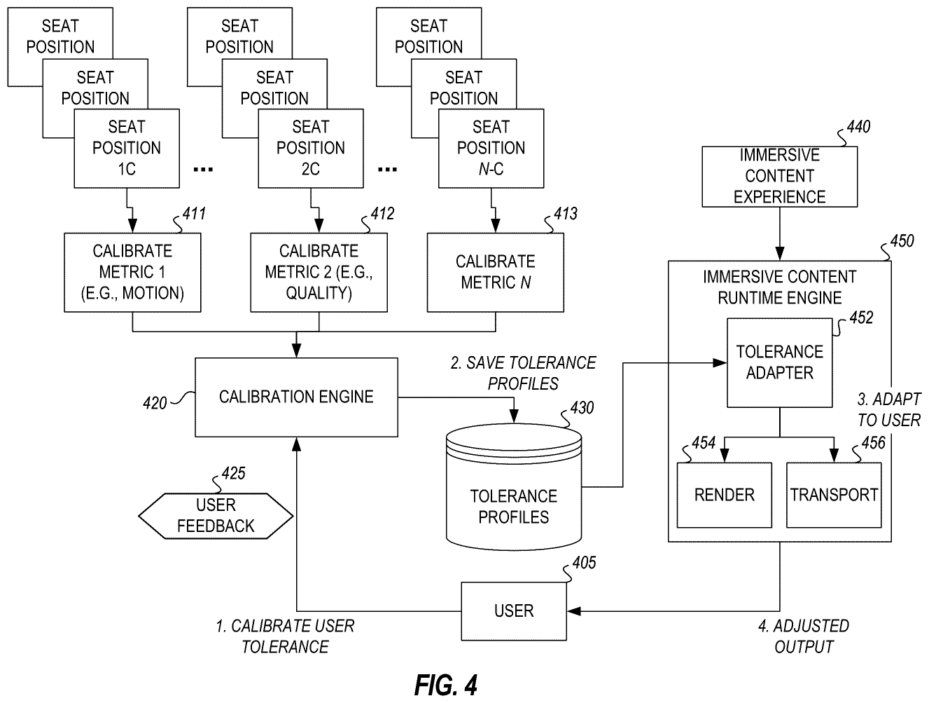

The user adaptation engine 310 includes a position detector 312 to detect a occupant position and a position recommender 314 to determine one or more recommended positions of a vehicle occupant. This engine 310 thus provides the capability to track the occupant position within the vehicle relative to the immersive content or type of immersive experience. Additionally, the engine 310 can provide a tight controlled loop feedback with the seat adaptation engine 320 to understand user's relative position changes and associated tolerance profile for content adaptation. More details on calibration and tolerance are provided below with reference to FIG. 4.

The user adaptation engine 310 may receive telemetry from the predictive content engine 360 for content display or playback recommendations. For instance, recommendations can adjust for ambient noise and sound reflection characteristics of the vehicle's interior. A vehicle with a single occupant will have less sound absorption properties than a vehicle fully occupied.

The seat adaptation engine 320 also provides the capability towards peer-to-peer seat posture calibration. The seat adaptation engine 320 coordinates with the user adaptation engine 310 to provide appropriate seat posture recommendations or changes, based on the content or content delivery (or based on changes to the content or content delivery).

In further examples, the information from the predictive content engine 360 and the user adaptation engine 310 can be used for advanced and seamless metering for the usage of immersive content and other services. As one example, the user can be charged more effectively by monitoring the user's context. For instance, the user may be charged only for the time duration over which the user was attentive to the infotainment service, and the media may be paused and not be charged when the user gets distracted, or heads-away from the screen, or dozes-off.

FIG. 4 is a flow diagram illustrating an example operational flow for RTASA operations. Here, this diagram shows how an RTASA engine can be used to coordinate receipt of sensory input and adapt calibration for specific client devices/users dynamically in real time. Further, the RTASA provides a feedback channel to optimize machine learning convergence.

The overall flow in FIG. 4 includes the consideration of a metric referred to as “tolerance.” Here, tolerance refers to aspects of change for the user experience relating to the degrading of one or more visual, audio, or sensory processing features. For example, consider a scenario where content is being rendered but is not fully optimized as an immersive experience based on the occupant's position in the vehicle (e.g., because the occupant has rotated their seat).

RTASA operations are able to adapt the content, whether video and audio and spatial content, vibration, or other aspects of the immersive experience, based on an acceptable tolerance. Additionally, tolerance can involve of ensuring user comfort and preventing motion sickness, especially due to the motion of the vehicle and seat position of a vehicle occupant. One simple example for tolerance may include the size of content, including to determine a personalized tolerance for a larger or clearer font based on a occupant's viewing angle or perspective. Likewise for audio, if a particular occupant cannot tolerate high pitch audio or loud sounds, then a system can implement customization to the audiovisual content to reduce the level of the audio.

An example of configuration for the RTASA system may include the following. Users (e.g., vehicle occupants) engage a one-time setup phase or policy configurable (as-needed basis) involving with following operations. First, a user is tested on a set of predetermined metrics (e.g., metrics 411, 412, 413) that affect the immersive content experience. Motion blur, refresh/frame rate mismatch (judder), and image quality are as provided as examples, but other types of audio or visual output metrics may also be evaluated. For example, each test may include presenting a set of contents, going from most to least tolerable level of that metric. A user is asked to rate each content on its tolerability. Ratings can be as simple as good/acceptable/unacceptable, or more detailed on a numerical scale of 1-10. Examples of tests might include: A set of static images ranging from best to worst resolution; A set of moving objects going from smooth to blurry; A set of sequences where the user must look around and the image catches up instantaneously, to progressively worse (induced latency). Some of the tests may happen automatically without user feedback, if possible. An example of auto-calibrating vision limitations are discussed in more detail below.

The calibration results produced by the calibration engine 420 are stored as part of a user profile (e.g., in a database 430 of tolerance profiles). A user interface may be provided to enable a user 405 (e.g., a vehicle occupant) to override or disable the calibration parameters with user feedback 425. In addition to one-time calibration steps, the processes can utilize auto-calibration for some of the metrics.

The tolerance profiles are then used by an immersive content runtime engine 450 to customize the delivery of an immersive content experience 440. An example of operation for the RTASA system may be provided as follows. First, the tolerance adapter 452 loads a user's tolerance profile (e.g., from the database 430) and notes the metrics that negatively affect them the most and the metrics that they can tolerate the most. The tolerance adapter 452 then adapts the content rendering 454 and transport 456 to provide adjusted output, including content rendering or transport adaptation as part of user and seat positioning. The user 405 then can provide explicit ratings via a user interface (e.g., after the immersive experience) to provide additional feedback and re-calibration concerning the adjusted output.

Accordingly, when rendering and presenting the content (via content rendering 454 and transport 467) adjustments are identified based on inputs from user feedback 425. Such adjustments can be made in the immersive content pipeline to immediately improve the metric that affects the user, at the cost of affecting the other metrics that the user is less sensitive to.

The RTASA systems may operate to continuously profile the user movement for the specific content (e.g., during the output of a game) along with other metrics (e.g., frame drops due to delayed rendering), and may build a heuristic to determine an appropriate tolerance profile. As a result, the tolerance profile can be quantified into different characteristic categories—such as resolution, audio, video quality, frame drops, etc.

One example of tolerance in RTASA implementations, using the discussed calibration metrics, includes the following scenario. If a user is sensitive to frame/refresh rate issues (judder) and not to quality, the rendering pipeline can use a higher frame rate but reduce resolution. The immersive experience pipeline may also choose to enable a more sophisticated re-projection algorithm to compensate for a user's head movement to make the motion smoother. If a user is more tolerant of frame/refresh rate issues (judder) but wishes to have better resolution, the pipeline may adjust accordingly to render at higher resolution at the cost of added latency. However, it will be understood that RTASA implementations are not limited to such uses or features.

Another example of tolerance in RTASA implementations includes coordination with occupant, seat, or other position recommendations, such as suggesting a seat position for an occupant based on ergonomic considerations. For example, based on a user profile for tolerance, a vehicle occupant is adaptively monitored to experience the content in a safe manner, and a seat position is recommended. Likewise, seat adaptation or controls can be automatically implemented, if the occupant wants to make seat positioning automatic according to content being consumed. Other aspects may include saving features in a user profile to help users experience in-vehicle content in a particular way (including, saving or persisting preferences to be stored as part of a rider profile).

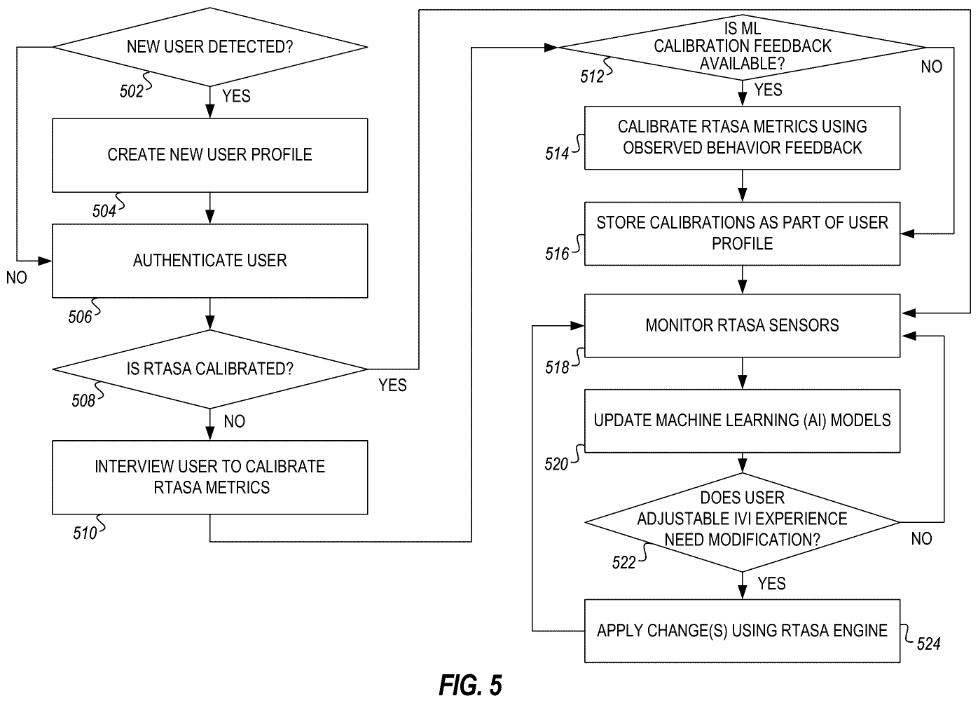

FIG. 5 is a flow chart illustrating configuration and operation of real-time autonomous seat adaptation. Specifically, this flow chart shows the setup, configuration and operational flow of the RTASA system and operations discussed throughout the previous drawings. This this operational flow also emphasizes aspects of user profiles and calibration (including, calibration for tolerances).

The flow chart of FIG. 5 includes two calibration inputs: a first input based on user interviews (e.g., in operation 510, discussed below), and a second input based on automated user feedback using observations of user behavior during operation (e.g., in operation 514, discussed below). If the user interviews are omitted, a secondary calibration mechanism may be used to automatically calibrate for user preference based on observed behavior.

The flow chart begins at decision 502, with a determination of whether a new user (e.g., occupant, whether a passenger or a driver) is detected in the vehicle. If a new user is detected, a new user profile is created at operation 504. At operation 506, operations are performed to authenticate the user. User authentication enables automated management of user-specific profiles for immersive media content. User authentication can utilize a variety of seamless user authentication capabilities such as wireless authentication tokens (e.g., FIDO tokens, wireless smart card, smartphone/watch with a Bluetooth low energy (BLE) authenticator, biometrics such as fingerprint scan, retinal scan, facial recognition, and the like).

The flow continues at decision 508 to determine whether the RTASA system is calibrated for the user. If calibrated, the system proceeds to monitor the RTASA sensors at operation 518. If not calibrated, the system performs calibration at operation 510 with the use of at least a user interview to calibrate the RTASA metrics.

In a further example, if machine learning (or other AI) calibration feedback is available, at decision 512, then the RTASA metrics may be calibrated using observed behavior feedback, followed by storage of the calibrations as part of the user profile at operation 516. If the machine learning calibration feedback is not available, then the calibrations (based on the user interface) are immediately stored as part of the user profile at operation 516.

The flow proceeds at operation 518 by monitoring of RTASA sensors. Based on the data produced from monitoring, further evaluation and decision making may be performed for immersive content and infotainment delivery. This may include, at operation 520, an update to machine learning (or other AI) models, and at decision 522, an evaluation of whether the user-adjustable in-vehicle infotainment (IVI) experience needs modification. If modification is needed, then changes are applied at operation 524 using the RTASA engine.

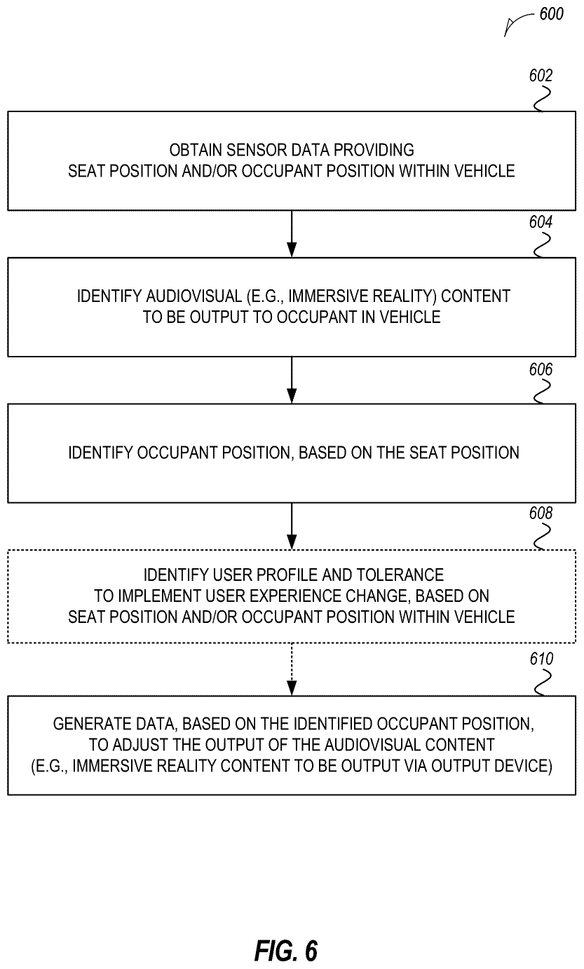

FIG. 6 illustrates a flowchart 600 of an example method for implementing real time autonomous seat adaptation, to cause content adaptation and/or content output adjustments. It will be understood that this method may be implemented by an implementing software stack, a control system, a vehicle, or other systems and subsystems discussed herein.

At 602, operations are performed to obtain sensor data providing seat position (and/or occupant position) within a vehicle. In an example, such sensor data is obtained via a communication interface to one or more sensors of the vehicle. For instance, the communication interface may be used to obtain occupant sensor data via the communication interface, with such occupant sensor data including values that indicate (or that are based on) a current position of the occupant in the vehicle.

At 604, operations are performed to identify audiovisual (e.g., immersive reality) content to be output to an occupant in the vehicle. As noted above, such content may be portions, segments, or aspects of an augmented reality (AR), virtual reality (AR), or immersive reality (IR) experience.

At 606, operations are performed to identify an occupant position of the human occupant, based on the seat position, or other sensors of the vehicle (including seat sensors, cameras, etc.). This occupant position may be identified and evaluated to determine the state or results of a user experience, that is output from the audiovisual content.

At 608, operations are performed to optionally identify a user profile and/or a tolerance to implement a user experience change, based on the seat position and/or the occupant position within the vehicle. As one example, a user profile of or associated with the occupant (or a group of occupants) may be obtained from a data store (e.g., database, memory, network connected source). As another example, data may be obtained to identify a tolerance for a change to the user experience, based on the occupant position and the seat position. Various adjustments to change the output of the audiovisual content (including, a rendering or transport of the audiovisual content) may be based on tolerance and/or user profile. As one specific example, a change to the user experience can involve at least one of a motion change, quality reduction, or content change of the audiovisual content, in a scenario where an identified tolerance for the change to the user experience is obtained from a tolerance profile in a user profile of the occupant (or a group formed from one or more occupants). Further aspects of calibration of this tolerance (e.g., calibrating a tolerance profile based on the seat position, user feedback from the occupant, and a type of the change to the user experience) may occur consistent with the examples above.

At 610, operations are performed to generate data, based on the identified occupant position, to cause an adjustment to the output of the audiovisual content (e.g., immersive reality content to be output via an output device). In a further example, at least one artificial intelligence model generates data that causes the adjustments to the output of the audiovisual content in the vehicle. In a further operation (not shown), the output device is caused to provide a presentation of the output of the audiovisual content in the vehicle, as an augmented reality (AR), virtual reality (AR), or immersive reality (IR) experience.

In further examples, a recommendation may be generated for a recommended occupant position of the human occupant or a recommended seat position of the seat of the occupant. In such a scenario, the output of the audiovisual content can be further based on the recommended occupant position or the recommended seat position. The recommended seat position may be implemented in the vehicle by additional operations that cause at least one command to be transmitted, to a controller, to change the seat position or a position of the output device in the vehicle (with the at least one command being based on the recommended occupant position or the recommended seat position). For instance, the vehicle may include a controller to implement and actuate one or more mechanisms based on such a command.

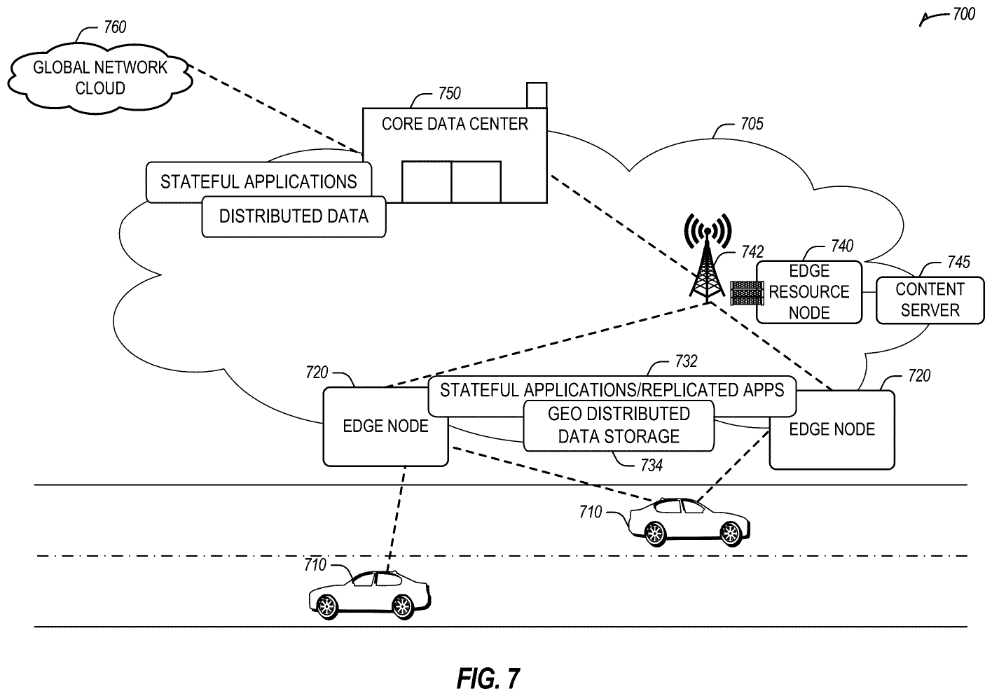

It should be appreciated that the systems and arrangements discussed herein may be applicable in various solutions, services, and/or use cases, including those in networked to cloud or edge computing services. As an example, FIG. 7 shows a simplified vehicle compute and communication use case involving mobile access to applications in a computing system 700 that implements an edge cloud 705. In this use case, each client compute node 710 may be embodied as in-vehicle compute systems (e.g., in-vehicle navigation and/or infotainment systems) located in corresponding vehicles that communicate with the edge gateway nodes 720 during traversal of a roadway. For instance, edge gateway nodes 720 may be located in roadside cabinets, which may be placed along the roadway, at intersections of the roadway, or other locations near the roadway. As each vehicle traverses along the roadway, the connection between its client compute node 710 and a particular edge gateway node 720 may propagate so as to maintain a consistent connection and context for the client compute node 710. Each of the edge gateway nodes 720 includes some processing and storage capabilities and, as such, some processing and/or storage of data for the client compute nodes 710 may be performed on one or more of the edge gateway nodes 720.

Each of the edge gateway nodes 720 may communicate with one or more edge resource nodes 740, which are illustratively embodied as compute servers, appliances or components located at or in a communication base station 742 (e.g., a base station of a cellular network). Each edge resource node 740 may include some processing and storage capabilities and, as such, some processing and/or storage of data for the client compute nodes 710 may be performed on the edge resource node 740. For instance, this may include a content server 745 which offers high-bandwidth immersive or multimedia content for the use cases discussed above. Additionally, the processing or serving of data that is less urgent or important may be performed by the edge resource node 740, while the processing of data that is of a higher urgency or importance may be performed by edge gateway devices or the client nodes themselves (depending on, for example, the capabilities of each component).

The edge resource node(s) 740 also communicate with the core data center 750, which may include compute servers, appliances, and/or other components located in a central location (e.g., a central office of a cellular communication network). The core data center 750 may provide a gateway to the global network cloud 760 (e.g., the Internet) for the edge cloud 705 operations formed by the edge resource node(s) 740 and the edge gateway nodes 720. Additionally, in some examples, the core data center 750 may include an amount of processing and storage capabilities and, as such, some processing and/or storage of data for the client compute devices may be performed on the core data center 750 (e.g., processing of low urgency or importance, or high complexity). The edge gateway nodes 720 or the edge resource nodes 740 may offer the use of stateful applications 732 and a geographic distributed data storage 734 (e.g., database, data store, etc.).

In further examples, FIG. 7 may utilize various types of mobile edge nodes, such as an edge node hosted in a vehicle (e.g., car, truck, tram, train, etc.) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 720, some others at the edge resource node 740, and others in the core data center 750 or global network cloud 760.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

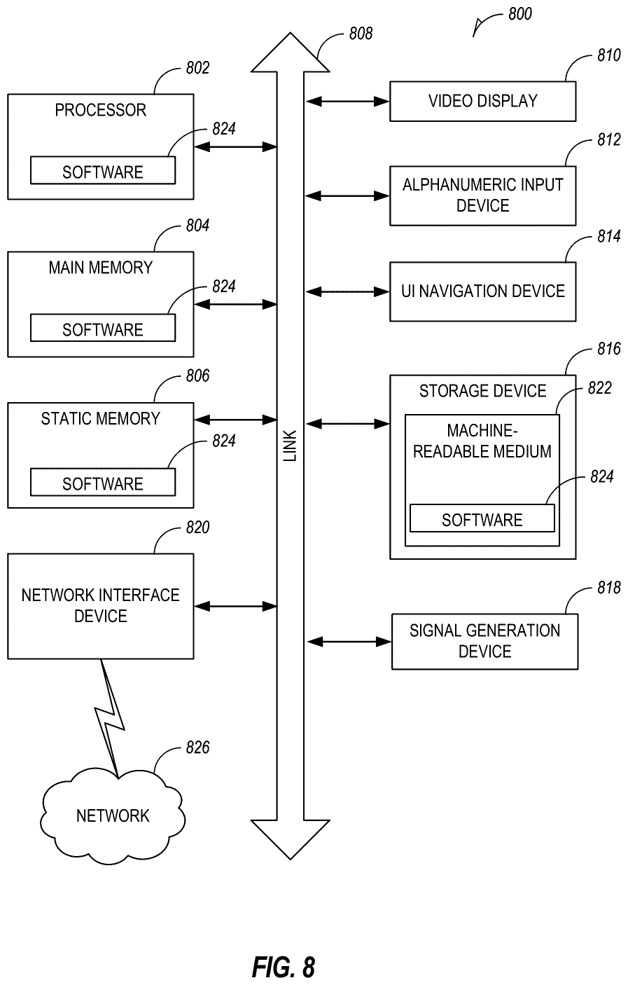

FIG. 8 is a block diagram illustrating a machine in the example form of a computer system 800, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, gyrometer, magnetometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include nonvolatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or satellite communication networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.
Example 1 is a system for content adaptation based on seat position in a vehicle, the system comprising: a communication interface to one or more sensors of the vehicle; and processing circuitry to: obtain sensor data, via the communication interface, the sensor data including a seat position of a seat in the vehicle; identify audiovisual content for output to a human occupant in the vehicle; identify an occupant position of the human occupant, based on the seat position, for a user experience of the output of the audiovisual content; and cause one or more adjustments to the output of the audiovisual content in the vehicle to the human occupant, via an output device, based on the identified occupant position.
In Example 2, the subject matter of Example 1 optionally includes the processing circuitry further to: obtain a user profile of the human occupant; wherein the adjustments to the output of the audiovisual content are further based on the user profile.
In Example 3, the subject matter of any one or more of Examples 1-2 optionally include the processing circuitry further to: identify a tolerance for a change to the user experience, based on the occupant position and the seat position; wherein the adjustments to the output of the audiovisual content are further based on the change to the user experience in a rendering or a transport of the audiovisual content.
In Example 4, the subject matter of Example 3 optionally includes wherein the change to the user experience relates to at least one of a motion change, quality reduction, or content change of the audiovisual content, and wherein the identified tolerance for the change to the user experience is obtained from a tolerance profile in a user profile of the human occupant or a group of users formed from one or more occupants.
In Example 5, the subject matter of Example 4 optionally includes wherein the tolerance profile is calibrated based on the seat position, user feedback from the human occupant, and a type of the change to the user experience.
In Example 6, the subject matter of any one or more of Examples 1-5 optionally include the processing circuitry further to: obtain occupant sensor data via the communication interface, the occupant sensor data based on a current position of the human occupant in the vehicle; and generate a recommendation for a recommended occupant position of the human occupant or a recommended seat position of the seat of the human occupant; wherein the adjustments to the output of the audiovisual content are further based on the recommended occupant position or the recommended seat position.
In Example 7, the subject matter of Example 6 optionally includes wherein the communication interface communicatively couples the processing circuitry to a controller, and wherein the processing circuitry is further to: cause at least one command to be transmitted, via the controller, to change the seat position or a position of the output device in the vehicle, the at least one command based on the recommended occupant position or the recommended seat position for the human occupant.
In Example 8, the subject matter of any one or more of Examples 1-7 optionally include wherein at least one artificial intelligence model is used to generate the one or more adjustments to the output of the audiovisual content in the vehicle.
In Example 9, the subject matter of any one or more of Examples 1-8 optionally include the processing circuitry further to: cause the output device to present the output of the audiovisual content, wherein the audiovisual content is presented in the vehicle as an augmented reality (AR), virtual reality (AR), or immersive reality (IR) experience.
Example 10 is at least one non-transitory machine-readable medium capable of storing instructions for content adaptation based on seat position in a vehicle, the instructions when executed by a machine, cause the machine to perform operations comprising: obtaining sensor data, the sensor data including a seat position of a seat in the vehicle; identifying audiovisual content for output to a human occupant in the vehicle; identifying an occupant position of the human occupant, based on the seat position, for a user experience of the output of the audiovisual content; and cause one or more adjustments to the output of the audiovisual content in the vehicle, via an output device, based on the identified occupant position.
In Example 11, the subject matter of Example 10 optionally includes the operations further comprising: obtaining a user profile of the human occupant; wherein the adjustments to the output of the audiovisual content are further based on the user profile.
In Example 12, the subject matter of any one or more of Examples 10-11 optionally include the operations further comprising: identifying a tolerance for a change to the user experience, based on the occupant position and based on the seat position; wherein the adjustments to the output of the audiovisual content are further based on the change to the user experience in a rendering or a transport of the audiovisual content.
In Example 13, the subject matter of Example 12 optionally includes wherein the change to the user experience relates to at least one of a motion change, quality reduction, or content change of the audiovisual content, and wherein the identified tolerance for the change to the user experience is obtained from a tolerance profile in a user profile of the human occupant or a group of users formed from one or more human occupants.
In Example 14, the subject matter of Example 13 optionally includes wherein the tolerance profile is calibrated based on the seat position, user feedback from the human occupant, and a type of the change to the user experience.
In Example 15, the subject matter of any one or more of Examples 10-14 optionally include the operations further comprising: obtaining occupant sensor data, the occupant sensor data based on a current position of the human occupant in the vehicle; and generating a recommendation for a recommended occupant position of the human occupant or a recommended seat position of the seat of the human occupant; wherein the adjustments to the output of the audiovisual content are further based on the recommended occupant position or the recommended seat position for the human occupant.
In Example 16, the subject matter of Example 15 optionally includes the operations further comprising: transmitting at least one command to change the seat position or a position of the output device in the vehicle, the at least one command based on the recommended occupant position or the recommended seat position.
In Example 17, the subject matter of any one or more of Examples 10-16 optionally include wherein at least one artificial intelligence model generates the data to adjust the output of the audiovisual content in the vehicle.
In Example 18, the subject matter of any one or more of Examples 10-17 optionally include the operations further comprising: controlling a presentation of the output of the audiovisual content, wherein the audiovisual content is presented in the vehicle as an augmented reality (AR), virtual reality (AR), or immersive reality (IR) experience.
Example 19 is an apparatus, comprising: sensing means for obtaining a seat position of a seat in a vehicle; and processing means for: identifying audiovisual content for output to a human occupant in the vehicle; identifying an occupant position of the human occupant, based on the seat position, for a user experience of the output of the audiovisual content; and causing one or more adjustments to the output of the audiovisual content in the vehicle, via an output device, based on the identified occupant position of the human occupant.
In Example 20, the subject matter of Example 19 optionally includes means for obtaining a user profile of the human occupant, wherein the adjustments to the output of the audiovisual content are further based on the user profile.
In Example 21, the subject matter of any one or more of Examples 19-20 optionally include means for calibrating a tolerance for a change to the audiovisual content, based on the occupant position and the seat position; wherein the adjustments to the output of the audiovisual content are further based on the change to the user experience in a rendering or a transport of the audiovisual content.
In Example 22, the subject matter of any one or more of Examples 19-21 optionally include means for obtaining occupant sensor data, the occupant sensor data based on a current position of the human occupant in the vehicle; wherein the processing means further generates a recommendation for a recommended occupant position of the human occupant or a recommended seat position of the seat of the human occupant; wherein adjustments to the output of the audiovisual content are further based on the recommended occupant position or the recommended seat position.
In Example 23, the subject matter of Example 22 optionally includes means for changing the seat position or a position of the output device in the vehicle, based on the recommended occupant position or the recommended seat position.
In Example 24, the subject matter of any one or more of Examples 19-23 optionally include means for presenting the output of the audiovisual content in the vehicle as an augmented reality (AR), virtual reality (AR), or immersive reality (IR) experience.
Example 25 is a method for content adaptation based on seat position in a vehicle, comprising: obtaining sensor data, the sensor data including a seat position of a seat in the vehicle; identifying audiovisual content for output to a human occupant in the vehicle; identifying an occupant position of the human occupant, based on the seat position, for a user experience of the output of the audiovisual content; and cause one or more adjustments to the output of the audiovisual content in the vehicle, via an output device, based on the identified occupant position.
In Example 26, the subject matter of Example 25 optionally includes obtaining a user profile of the human occupant; wherein the adjustments to the output of the audiovisual content are further based on the user profile.
In Example 27, the subject matter of any one or more of Examples 25-26 optionally include identifying a tolerance for a change to the user experience, based on the occupant position and based on the seat position; wherein the adjustments to the output of the audiovisual content are further based on the change to the user experience in a rendering or a transport of the audiovisual content.
In Example 28, the subject matter of Example 27 optionally includes wherein the change to the user experience relates to at least one of a motion change, quality reduction, or content change of the audiovisual content, and wherein the identified tolerance for the change to the user experience is obtained from a tolerance profile in a user profile of the human occupant or a group of users formed from one or more human occupants.
In Example 29, the subject matter of Example 28 optionally includes wherein the tolerance profile is calibrated based on the seat position, user feedback from the human occupant, and a type of the change to the user experience.
In Example 30, the subject matter of any one or more of Examples 25-29 optionally include obtaining occupant sensor data, the occupant sensor data based on a current position of the human occupant in the vehicle; and generating a recommendation for a recommended occupant position of the human occupant or a recommended seat position of the seat of the human occupant; wherein the adjustments to the output of the audiovisual content are further based on the recommended occupant position or the recommended seat position.
In Example 31, the subject matter of Example 30 optionally includes transmitting at least one command to change the seat position or a position of the output device in the vehicle, the at least one command based on the recommended occupant position or the recommended seat position.
In Example 32, the subject matter of any one or more of Examples 25-31 optionally include wherein at least one artificial intelligence model generates the data to adjust the output of the audiovisual content in the vehicle.
In Example 33, the subject matter of any one or more of Examples 25-32 optionally include controlling a presentation of the output of the audiovisual content, wherein the audiovisual content is presented in the vehicle as an augmented reality (AR), virtual reality (AR), or immersive reality (IR) experience.
Example 34 is a method to perform operations, an apparatus configured to perform operations, or a machine-readable medium including instructions that cause processing circuitry to perform operations of any of Examples 1-33, enhanced with personalization for a human occupant or a group of occupants, based on the audiovisual content being output.
Example 35 is a method to perform operations, an apparatus configured to perform operations, or a machine-readable medium including instructions that cause processing circuitry to perform operations of any of Examples 1-34, enhanced with split screen rendering, and optionally, adapting or preventing the output of inappropriate audiovisual content in audio or video devices.
Example 36 is a method to perform operations, an apparatus configured to perform operations, or a machine-readable medium including instructions that cause processing circuitry to perform operations of any of Examples 1-35, enhanced with tracking functionality for seamless content delivery, including optionally, audiovisual content pre-fetch, orchestration, or migration across one or more autonomous vehicles.
Example 37 is a method to perform operations, an apparatus configured to perform operations, or a machine-readable medium including instructions that cause processing circuitry to perform operations of any of Examples 1-36, enhanced with geo-fenced/time-fenced isolation zones, that enable ad-hoc collaboration opportunities between one or more autonomous vehicles or subsystems.
Example 38 is at least one machine-readable medium including instructions that, when executed by processing circuitry, cause the processing circuitry to perform operations to implement of any of Examples 1-37.
Example 39 is an apparatus comprising means to implement of any of Examples 1-37.
Example 40 is a system to implement of any of Examples 1-37.
Example 41 is a method to implement of any of Examples 1-37.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for content adaptation based on seat position in a vehicle, the system comprising:
a communication interface to one or more sensors of the vehicle; and
processing circuitry to:
obtain sensor data, via the communication interface, the sensor data including a seat position of a seat in the vehicle;
identify audiovisual content for output to a human occupant in the vehicle;
identify an occupant position of the human occupant, based on the seat position, for a user experience of the output of the audiovisual content; and
cause one or more adjustments to the output of the audiovisual content in the vehicle to the human occupant, via an output device, based on the identified occupant position.

2. The system of claim 1, the processing circuitry further to:
obtain a user profile of the human occupant;
wherein the adjustments to the output of the audiovisual content are further based on the user profile.

3. The system of claim 1, the processing circuitry further to:
identify a tolerance for a change to the user experience, based on the occupant position and the seat position;
wherein the adjustments to the output of the audiovisual content are further based on the change to the user experience in a rendering or a transport of the audiovisual content.

4. The system of claim 3, wherein the change to the user experience relates to at least one of a motion change, quality reduction, or content change of the audiovisual content, and wherein the identified tolerance for the change to the user experience is obtained from a tolerance profile in a user profile of the occupant or a group of users formed from one or more occupants.

5. The system of claim 4, wherein the tolerance profile is calibrated based on the seat position, user feedback from the human occupant, and a type of the change to the user experience.

6. The system of claim 1, the processing circuitry further to:
obtain occupant sensor data via the communication interface, the occupant sensor data based on a current position of the human occupant in the vehicle; and
generate a recommendation for a recommended occupant position of the human occupant or a recommended seat position of the seat of the human occupant;
wherein the adjustments to the output of the audiovisual content are further based on the recommended occupant position or the recommended seat position.

7. The system of claim 6, wherein the communication interface communicatively couples the processing circuitry to a controller, and wherein the processing circuitry is further to:
cause at least one command to be transmitted, via the controller, to change the seat position or a position of the output device in the vehicle, the at least one command based on the recommended occupant position or the recommended seat position for the human occupant.

8. The system of claim 1, wherein at least one artificial intelligence model is used to generate the one or more adjustments to the output of the audiovisual content in the vehicle.

9. The system of claim 1, the processing circuitry further to:
cause the output device to present the output of the audiovisual content, wherein the audiovisual content is presented in the vehicle as an augmented reality (AR), virtual reality (AR), or immersive reality (IR) experience.

10. At least one non-transitory machine-readable medium capable of storing instructions for content adaptation based on seat position in a vehicle, the instructions when executed by a machine, cause the machine to perform operations comprising:
obtaining sensor data, the sensor data including a seat position of a seat in the vehicle;
identifying audiovisual content for output to a human occupant in the vehicle;
identifying an occupant position of the human occupant, based on the seat position, for a user experience of the output of the audiovisual content; and
cause one or more adjustments to the output of the audiovisual content in the vehicle, via an output device, based on the identified occupant position.

11. The at least one non-transitory machine-readable medium of claim 10, the operations further comprising:
obtaining a user profile of the human occupant;
wherein the adjustments to the output of the audiovisual content are further based on the user profile.

12. The at least one non-transitory machine-readable medium of claim 10, the operations further comprising:
identifying a tolerance for a change to the user experience, based on the occupant position and based on the seat position;
wherein the adjustments to the output of the audiovisual content are further based on the change to the user experience in a rendering or a transport of the audiovisual content.

13. The at least one non-transitory machine-readable medium of claim 12, wherein the change to the user experience relates to at least one of a motion change, quality reduction, or content change of the audiovisual content, and wherein the identified tolerance for the change to the user experience is obtained from a tolerance profile in a user profile of the human occupant or a group of users formed from one or more occupants.

14. The at least one non-transitory machine-readable medium of claim 13, wherein the tolerance profile is calibrated based on the seat position, user feedback from the human occupant, and a type of the change to the user experience.

15. The at least one non-transitory machine-readable medium of claim 10, the operations further comprising:
obtaining occupant sensor data, the occupant sensor data based on a current position of the human occupant in the vehicle; and
generating a recommendation for a recommended occupant position of the human occupant or a recommended seat position of the seat of the human occupant;
wherein the adjustments to the output of the audiovisual content are further based on the recommended occupant position or the recommended seat position for the human occupant.

16. The at least one non-transitory machine-readable medium of claim 15, the operations further comprising:
transmitting at least one command to change the seat position or a position of the output device in the vehicle, the at least one command based on the recommended occupant position or the recommended seat position.

17. The at least one non-transitory machine-readable medium of claim 10, wherein at least one artificial intelligence model generates the data to adjust the output of the audiovisual content in the vehicle.

18. The at least one non-transitory machine-readable medium of claim 10, the operations further comprising:
controlling a presentation of the output of the audiovisual content, wherein the audiovisual content is presented in the vehicle as an augmented reality (AR), virtual reality (AR), or immersive reality (IR) experience.

19. An apparatus, comprising:
sensing means for obtaining a seat position of a seat in a vehicle; and
processing means for:
identifying audiovisual content for output to a human occupant in the vehicle;
identifying an occupant position of the human occupant, based on the seat position, for a user experience of the output of the audiovisual content; and
causing one or more adjustments to the output of the audiovisual content in the vehicle, via an output device, based on the identified occupant position.

20. The apparatus of claim 19, further comprising:
means for obtaining a user profile of the human occupant, wherein the adjustments to the output of the audiovisual content are further based on the user profile.

21. The apparatus of claim 19, further comprising:
means for calibrating a tolerance for a change to the audiovisual content, based on the occupant position and the seat position;
wherein the adjustments to the output of the audiovisual content are further based on the change to the user experience in a rendering or a transport of the audiovisual content.

22. The apparatus of claim 19, further comprising:
means for obtaining occupant sensor data, the occupant sensor data based on a current position of the human occupant in the vehicle;
wherein the processing means further generates a recommendation for a recommended occupant position of the human occupant or a recommended seat position of the seat of the human occupant; and
wherein adjustments to the output of the audiovisual content are further based on the recommended occupant position or the recommended seat position.

23. The apparatus of claim 22, further comprising:
means for changing the seat position or a position of the output device in the vehicle, based on the recommended occupant position or the recommended seat position.

24. The apparatus of claim 19, further comprising:
means for presenting the output of the audiovisual content in the vehicle as an augmented reality (AR), virtual reality (AR), or immersive reality (IR) experience.
